(19) United States
(12) Patent Application Publication
(10) Pub. No.: US 2022/0181837 A1
(43) Pub. Date: Jun. 9, 2022

(54) Polarization-Maintaining Fiber Laser Tunable Over Two Micron Region

(71) Applicant: Cybel, LLC., Bethlehem, PA (US)

(72) Inventors: Jean-Marc Delavaux, Pittstown, NJ (US); Robert E. Tench, Allentown, PA (US); Alexandre Amavigan, Whitehall, PA (US)

(73) Assignee: Cybel, LLC., Bethlehem, PA (US)

(21) Appl. No.: 17/116,508

(22) Filed: Dec. 9, 2020

(51) Int. Cl. H01S 3/106; H01S 3/067; H01S 3/16

(52) U.S. Cl. CPC H01S 3/106; H01S 3/06791; H01S 3/06733; H01S 3/161; H01S 3/06716

(57) ABSTRACT

A wavelength-tunable, polarization-maintaining (PM) fiber laser for use in the two micron wavelength region is based upon a ring laser geometry and includes sections of polarization-maintaining (PM) optical fiber for supporting propagation of the circulating laser radiation around the ring. At least one gain module is included in the ring and is formed of polarization-maintaining active optical fiber including a core region that is doped with either Thulium (Tm) or Holmium (Ho), or co-doped with both of these rare earth materials. In the presence of a pump beam operating at a suitable wavelength, the gain module(s) generate laser radiation at a wavelength within the two micron region. A PM-based tunable bandpass filter (BPF) is included within the ring and used to control/adjust the wavelength of the output beam provided by the fiber laser.

### TECHNICAL FIELD

The present invention relates to wavelength tunable fiber lasers and, more particularly, to polarization-maintaining fiber lasers that are tunable across a portion of the spectrum in the two micron region.

### BACKGROUND OF THE INVENTION

Tunable, narrow-linewidth single-frequency lasers in the two micron region are important as sources for mid-IR generation, LIDAR, DWDM and coherent communication systems, as well as instrumentation applications such as infrared spectroscopy and gas sensing. Tm-doped fiber lasers (TDFLs) are known as operable sources in this region, providing output powers of 1 mW and tunable over a region within the bandwidth of about 1650-2000 nm.

While having success at tuning the output wavelength of a TDFL over a usable range, these sources to date have not maintained the desired polarization stability required for many of the above-cited applications, particularly as required for coherent systems and many spectroscopy applications. While there have been efforts at realizing a polarization-maintaining (PM) TDFL, these have been found to be limited in operation to a single wavelength, with no tuning capability.

### SUMMARY OF THE INVENTION

The needs remaining in the prior art are addressed by the present invention, which relates to polarization-maintaining fiber lasers that are tunable across a portion of the spectrum in the two micron region.

In accordance with the teachings of the present invention, a wavelength tunable fiber laser is based upon a ring laser geometry and includes sections of polarization-maintaining (PM) optical fiber for supporting propagation of the circulating laser radiation around the ring. At least one gain module is included in the ring and is formed of polarization-maintaining active optical fiber including a core region that is doped with either Thulium (Tm) or Holmium (Ho), or co-doped with both of these rare earth materials. In the presence of a pump beam operating at a suitable wavelength, the gain module(s) will generate laser radiation at a wavelength within the two micron region. In further accordance with the present invention, a tunable bandpass filter (BPF) that is also formed as a polarization-maintaining component is included within the ring and used to control/adjust the wavelength of the output beam provided by the fiber laser. The PM-based tunable BPF may be formed from a number of different components (gratings, dichroic filters, etc.), with the tuning range and linewidth of the inventive PM fiber laser being a function of the particular design of the PM-based tunable BPF.

One or more embodiments of the present invention including an amplifier booster stage coupled to the output of a tunable PM fiber ring laser for applications that require a higher output power (e.g., multi-watt power levels).

As exemplary embodiment of the present invention may take the form of a wavelength-tunable, PM fiber laser operable in the two micron region, the fiber laser based upon a PM ring resonator structure, with a separate pump source used to generate an input beam at a wavelength known to create gain in the presence of a particular dopant. In particular, PM ring resonator structure includes a gain module of PM optical fiber including a dopant selected from the group consisting of: Thulium (Tm), Holmium (Ho), and Thulium-Holmium (Tm—Ho), a PM-based, tunable BPF for selecting a particular laser output wavelength from within the two micron region, and a PM output coupler for out-coupling a defined portion of the laser radiation generated at the selected output wavelength within the gain module, a remaining portion of the laser radiation continuing to circulate within the resonator provide a continuous laser radiation output from the ring resonator structure.

Another embodiment of the present invention is configured to generate higher output power levels by adding a power boosting fiber amplifier to the output from the ring resonator.

Other and further advantages and aspects of the present invention will become apparent during the course of the following discussion and by reference to the accompanying drawings.

### BRIEF DESCRIPTION OF THE DRAWINGS

Referring now to the drawings,

FIG. 1 illustrates an exemplary tunable fiber ring laser formed in accordance with the principles of the present invention;

FIG. 2 depicts an alternative configuration of the tunable fiber ring laser of FIG. 1, in this case having the circulating radiation propagating around the ring in a counter-clockwise direction;

FIG. 3 shows another alternative of the embodiment of FIG. 1, in this case utilizing a polarization-maintaining optical circulator to introduce the pump beam into the ring;

FIG. 4 illustrates yet another configuration, in this case using a pair of three-port polarization-maintaining optical circulators;

FIG. 5 shows a compact embodiment utilizing a four-port polarization-maintaining optical coupler to interconnect the pump source, gain module, and polarization-maintaining bandpass filter;

FIG. 6 illustrates another embodiment of a tunable fiber ring laser formed in accordance with the principles of the present invention, in this case using a pair of gain modules within the ring;

FIG. 7 shows an alternative configuration of the embodiment of FIG. 6, in this case positioning the second gain module immediately prior to the ring's output coupler;

FIG. 8 illustrates a two-stage fiber laser formed in accordance with the present invention, comprising a fiber ring laser as shown in any of the above-defined illustrations, with an output power amplifier stage (“booster stage”) connected to the output coupler of the ring;

FIG. 9 shows an exemplary output spectrum from the two-stage fiber laser of FIG. 8;

FIG. 10 illustrates an alternative configuration of the embodiment of FIG. 8, in this case using a polarization-maintaining optical circulator to introduce the pump beam to the fiber ring;

FIG. 11 depicts a “hybrid” two-stage fiber laser of the present invention, where the ring portion utilizes an Ho-doped gain module and the output booster stage utilizes a Tm-doped gain module; and

FIG. 12 illustrates an alternative configuration of the hybrid fiber laser of FIG. 11, in this case using a specialized, single pump source that supplies pump signals of appropriate wavelengths to each of the gain modules.

### DETAILED DESCRIPTION

A fiber ring laser may be constructed by using a closed fiber loop to form a ring-shaped optical resonator. The fiber ring laser includes at least a portion of a doped fiber as the laser gain medium to produce an optical gain within a desired spectral range in response to an optical pump beam. As mentioned above, the optical pump beam is selected to operate at pump wavelength (or within a specified pump spectral range) that is known to interact with the particular dopant in the gain medium.

A laser oscillation in the fiber ring occurs at a laser wavelength within the gain spectral range when two operating conditions are met. First, the total optical gain at that laser wavelength exceeds the total optical loss in the fiber ring, and secondly, an accumulated optical phase delay of 360° (or a multiple thereof) associated with a round trip around the fiber ring.

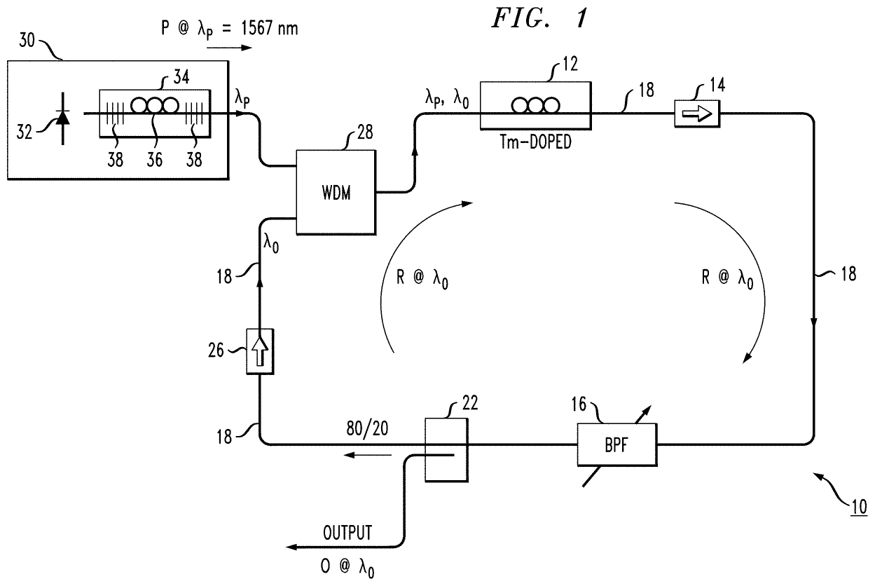

FIG. 1 illustrates an exemplary tunable fiber ring laser 10 formed in accordance with the principles of the present invention. Fiber ring laser 10 is shown as embodying the circular oscillator structure briefly described above, and for the purposes of the present invention is formed of sections of polarization-maintaining (PM) optical fiber used in combination with polarization-maintaining optical components to create a resonant structure. In particular, tunable PM fiber ring laser 10 is based upon generating laser radiation within a gain module 12 that is formed to include a section of polarization-maintaining doped fiber. For operation within the two micron region, gain module 12 may comprise Tm-doped optical fiber, Ho-doped optical fiber, or Tm—Ho co-doped optical fiber, as a function of the particular output wavelength tuning range of interest. It is an advantage of the various implementations of a tunable fiber laser of the present invention that different dopants may be utilized within the different gain modules. For example, it is known that Tm-doped gain fiber provides optimum results along the wavelength region from about 1700 nm to 2000 nm. On the other hand, Ho-doped gain fiber performs better than Tm-doped gain fiber along the wavelength range extending from about 2000-2150 nm. Regardless of the dopant selection, it is required that gain module 12 comprise a section of polarization-maintaining optical fiber.

In accordance with the principles of the present invention, a polarization-maintaining, tunable bandpass filter (BPF) 16 is included within tunable PM-fiber ring laser 10 and controlled (adjusted) to select the specific wavelength (defined herein as “λ₀”) within the two micron region that is to be used as the output wavelength of tunable PM-fiber ring laser 10. PM-based tunable BPF 16 may comprise a single wavelength device (e.g., a combination of an optical circulator with a reflective fiber Bragg grating (FBG) structure), or a broadband device based on a dichroic filter or grating-based structure or a tunable electro-optic filter. Various other types and structures of BPFs are well-known in the art and are useful in the fiber laser of the present invention. Polarization control within the BPF itself is typically achieved by positioning a linear polarizer at the input to the BPF, and another linear polarization at the output, thus ensuring that only the desired polarization is preserved within the ring. The tuning range, as well as the linewidth of the filtered beam, are design considerations associated with the selected tunable BPF. The adjustment of the center wavelength of PM-based, tunable BPF 16 to a desired value of λ₀ may be accomplished by using temperature adjustments, electrical signal controls and/or mechanical movements of an associated grating or dichroic filter structure, as well as other tuning techniques well-known in the art. In some cases, the wavelength tuning is performed during assembly of the fiber ring laser and is thereafter “fixed”. For some applications, however, it is desirable to provide a tunable fiber laser where the output wavelength may be actively tuned during operation of the laser; for these situations, PM-based, tunable BPF 16 is designed as an active device with a filter center wavelength that is tunable as a function of time (i.e., λ₀(t)).

Since the laser radiation circulates around the ring in a continuous fashion, it passes through PM-based, tunable BPF 16 multiple times, thus maintaining stability of the laser output wavelength as related to the essentially continuous filtering. For the purposes of discussion, it is presumed that the generated laser radiation R is propagating at a wavelength λ₀ selected from the two micron region, extending generally across the spectral region of 1700-2150 nm, as controlled by the type of dopant used within the gain fiber and the parameters of PM-based, tunable BPF 16.

In accordance with the principles of operation of a fiber ring laser, a pump beam P is used to initiate and maintain the generation of the laser output emission. In the particular example of FIG. 1, it is presumed that gain module 12 comprises a section of polarization-maintaining Tm-doped optical fiber, which is known to create gain in the spectral region of 1700-2100 nm in the presence of a pump beam P operating at a pump wavelength λ_{P} of about 1567 nm. A pump source 30 is included as a component of tunable fiber ring laser 10 and used to supply pump beam P to gain module 12. It is to be noted that the use of a Tm-doped PM fiber in the illustration of FIG. 1 is exemplary only; gain module 12 may also comprise a section of Ho-doped PM fiber (preferred for the spectral range of 1940-2150 nm), or even Tm—Ho co-doped PM fiber (with a spectral range of about 1900-2150 nm), the Ho dopant being activated in the presence of a pump beam operating at a wavelength of 1940 nm (or, possibly, 1860 nm).

Pump source 30 may take the form of a discrete semiconductor laser designed to emit at the pump wavelength, or an amplified laser (e.g., MOPA) configuration, or (as shown here) a fiber laser arrangement. In this particular configuration of a fiber laser arrangement for pump source 30, an uncooled diode laser 32 operating at a wavelength of 940 nm is used as the light source, with the output from diode laser 32 coupled into a fiber laser 34 that comprises a section of Er—Yb co-doped optical fiber 36 (which does not need to be polarization-maintaining for use in the pump source) disposed between a pair of fiber Bragg gratings (FBGs) 38 designed to create an output at the desired pump wavelength λ_{P} of 1567 nm.

As shown in FIG. 1, pump beam P is provided as an input to gain module 12 via a polarization-maintaining wavelength division multiplexer (WDM) 28. Polarization-maintaining WDM 28 is positioned along the ring structure so as to also receive as an input the circulating laser radiation R propagating at the selected (filtered) wavelength λ₀ associated with the generated laser output. WDM 28 thus combines the beams operating at these two wavelengths onto the same polarization-maintaining output path, which is coupled to the input of gain module 12. In this exemplary embodiment of FIG. 1, therefore, pump beam P is co-propagating with laser radiation R through gain module 12. It is to be understood that the signal path between pump source 30 and polarization-maintaining WDM 28 may simply comprise a section of standard (i.e., non-PM) optical fiber, since polarization control is only required within the ring structure to maintain a coherent, lasing environment.

A polarization-maintaining output coupler 22 is shown as an additional component of tunable PM-fiber ring laser 10, where output coupler 22 is designed to out-couple (tap) a defined portion of the circulating laser radiation R as the laser output “O” (operating at λ₀) from tunable PM-fiber ring laser 10. In an exemplary embodiment, an 80/20 coupler may be used, with 80% of the radiation power forming laser output beam O, and the remaining 20% continuing to circulate and provide the continuous amplification required for lasing (it is to be understood that this power splitting ratio is exemplary only, and other values may be more appropriate for a specific application). In accordance with the principles of the present invention, the use of PM optical fiber and PM components within the ring structure ensures that the laser output beam O is polarized as well, a requirement for various applications.

Tunable PM-fiber ring laser 10 maintains its uni-directional circulation of the laser radiation in this embodiment through the use of polarization-maintaining optical isolators. In particular, tunable PM-fiber ring laser 10 includes a first PM optical isolator 14 disposed between the output of gain module 12 and the input to PM-based, tunable BPF 16. A second PM optical isolator 26 is disposed between PM output coupler 22 and polarization-maintaining WDM 28. Individual lengths of PM optical fiber 18 are utilized to interconnect the various PM optical components to form the “loop” topology of the ring structure.

In accordance with the principles of the present invention, the presence of a pump beam operating at λp of 1567 nm within a section of polarization-maintaining Tm-doped optical fiber (such as used within gain module 12) results in creating laser radiation R operating at a wavelength λ₀ within the two micron region, as selected by tunable BPF 16. Tunable filters useful for this purpose may provide a linewidth of less than about 0.05 nm, providing suitable isolation between adjacent wavelengths that may be selected. The combination of polarization-maintaining components as shown in FIG. 1 thus provides a tunable laser source in the two micron region that is able to maintain a given polarization (e.g., linear polarization) as required for various applications, as mentioned above.

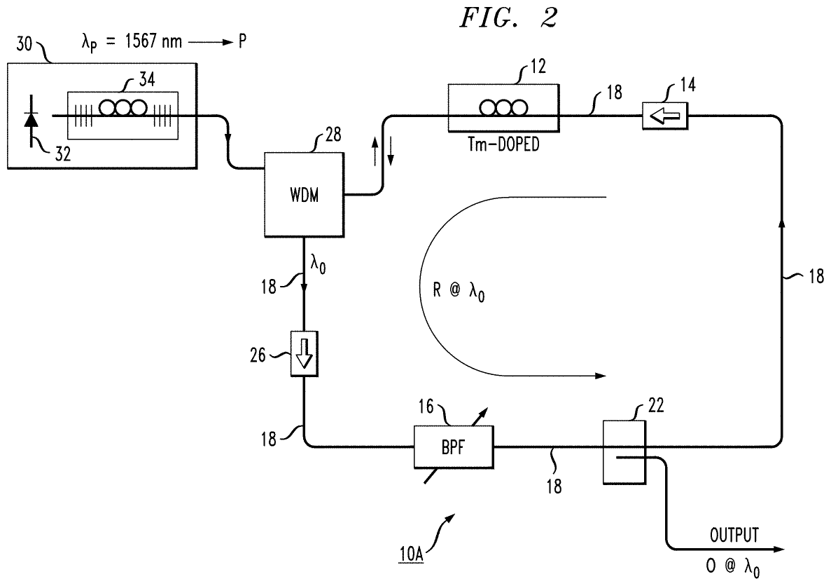

FIG. 2 illustrates an exemplary tunable PM-fiber ring laser 10A similar in form to the arrangement of FIG. 1, the difference being the directional orientation of first PM optical isolator 14 and second PM optical isolator 26. In this case, the propagating polarized laser radiation R circulates around the fiber ring in the counter-clockwise direction, with output coupler 22 similarly re-oriented to out-couple a portion of the circulating beam as the output O from tunable PM-fiber ring laser 10A. With this configuration, pump beam P counter-propagates through gain module 12 with respect to the propagation direction of laser radiation R. It is to be noted that in the embodiments of both FIGS. 1 and 2, PM-based, tunable BPF 16 is positioned immediately prior to PM output coupler 22, minimizing the amount of noise that may be present in the fiber laser output beam O, and thus optimizing the optical signal to noise ratio (OSNR) of tunable PM-fiber ring laser 10, 10A as formed in accordance with these embodiments of the present invention.

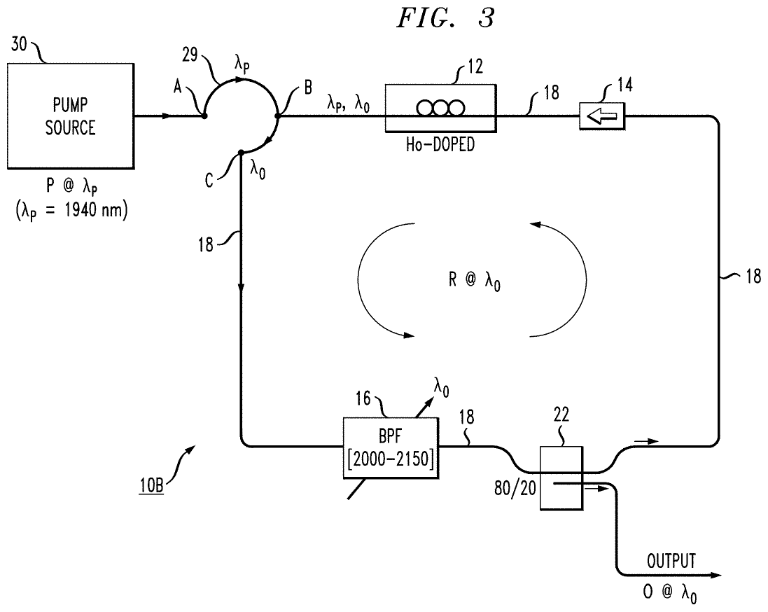

FIG. 3 shows yet another configuration of tunable PM-fiber ring laser 10, identified as tunable PM-fiber ring laser 10B. In comparison to the arrangement of FIG. 2, polarization-maintaining WDM 28 and PM optical isolator 26 are replaced in tunable PM-fiber ring laser 10B by a polarization-maintaining, three-port optical circulator 29. It is to be understood that optical circulators may only be used in specific applications where the signal and pump wavelengths are within the operating bandwidth of the circulator. Given this limitation, fiber lasers based on Tm-doped fiber are not suitable candidates for use in a circulator-based embodiment, since the pump wavelength of 1567 nm is outside the transmission band of an optical circulator formed to transmit signals in the two micron region. Thus, circulator-based configurations of the present invention include either Ho-doped gain modules or Tm—Ho co-doped gain modules. For example, when using a Ho-doped gain module to provide a laser output in the 2000-2150 nm wavelength range, the associated pump wavelength of 1940 nm (or 1860 nm) is also within the transmission bandwidth of an optical circulator.

In accordance with this embodiment of the present invention, three-port PM optical circulator 29 controls the movement of incoming pump beam P and circulating laser radiation R within the ring structure of the fiber laser, particularly with respect to their interaction within gain module 12. As shown, pump beam P from pump source 30 (operating at circulator-appropriate pump wavelength λ_{P}) is introduced into a first port A of optical circulator 29, and propagates around to exit at a second port B that is coupled to gain module 12. Thus, pump beam P is introduced into the doped PM optical fiber forming gain module 12 (either Ho-doped PM fiber or Tm—Ho co-doped PM fiber, for the reasons mentioned above). The generated output laser radiation R from gain module 12 (operating at selected output wavelength λ₀ from the Ho related wavelength range of about 2000-2150 nm) is shown as propagating counter-clockwise within the ring structure so as to enter optical circulator 29 at second port B and thereafter propagate along a polarization-maintaining path within the circulator to exit at a third port C. As with the arrangement of FIG. 2, laser radiation R thereafter propagates along PM optical fiber 18 before reaching PM-based, tunable BPF 16. The selected operating wavelength λ₀ is controlled by PM-based, tunable BPF 16 in a known fashion, with the filtered output therefrom directed into PM output coupler 22.

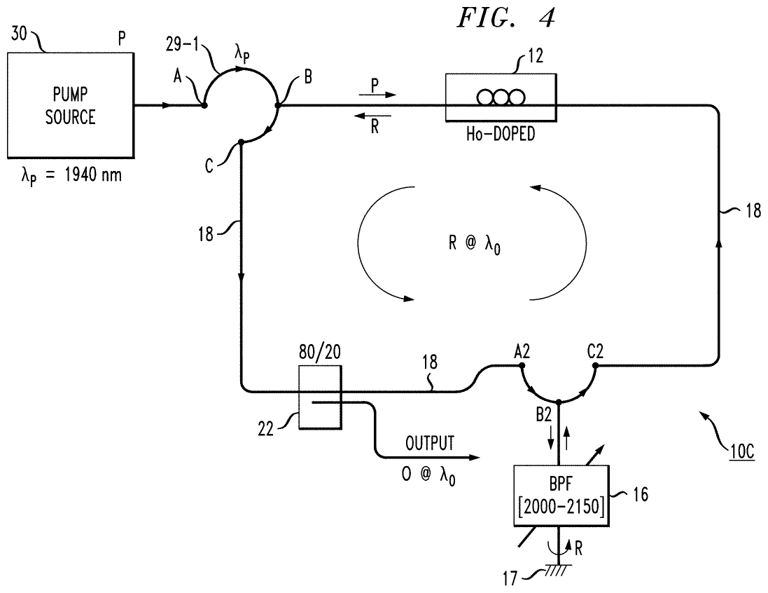

FIG. 4 illustrates yet another embodiment of tunable PM-fiber ring laser 10 that utilizes an optical circulator to introduce the pump beam to the ring. In particular, a tunable PM-fiber ring laser 10C utilizes a pair of PM three-port optical circulators 29-1 and 29-2 to provide directional control of the circulating laser radiation R and its interaction with pump source 30, gain module 12 (as with FIG. 3, based on either an Ho-doped PM fiber or a Tm—Ho co-doped PM fiber), and PM-based, tunable BPF 16. First PM optical circulator 29-1 functions in the same manner as PM optical circulator 29 of tunable PM-fiber ring laser 10B of FIG. 3; that is, introducing pump beam P to gain module 12 and controlling the counter-clockwise propagation direction of amplified laser radiation R from gain module 12 into PM optical fiber 18.

For the configuration of tunable PM-fiber ring laser 10C, PM output coupler 22 is shown as coupled to output port C of PM optical circulator 29-1 by a section of PM optical fiber 18. In the particular embodiment of FIG. 4, PM-based, tunable BPF 16 is coupled to a port of a second PM optical circulator 29-2, disposed as shown between PM output coupler 22 and gain module 12. Second PM optical circulator 29-2 is used in this embodiment of the present invention to direct the retained portion of the circulating laser radiation R into PM-based, tunable BPF 16.

In particular, the retained remaining portion of the circulating amplified radiation R from output coupler 22 is coupled to a first port A2 of second PM optical circulator 29-2, propagating along a PM signal path within optical circulator 29-2 and exiting a second port B2. As shown, PM-based, tunable BPF 16 is positioned along a linear signal path at second port B2, with a reflector 17 disposed beyond the termination of tunable BPF 16. The circulating laser radiation R exiting at second port B2 propagates through tunable BPF 16 in a first direction, and is then re-directed back into tunable BPF 16 by reflector 17. The filtered radiation exiting tunable BPF 16 is thereafter re-introduced into second port B2 and continues to propagate through second PM optical circulator 29-2, exiting at a third port. PM optical fiber 18 is shown as coupled between third port C2 and the input to gain module 12, where the use of an optical circulator along this path eliminates the need for a PM optical isolator to be in place between tunable BPF 16 and gain module 12.

Again, it is to be understood that the circulator-based configuration of tunable PM-fiber ring laser 10C cannot be used with a Tm-doped gain module, since the pump beams that may be used to react with the Tm dopant are outside of the transmission bandwidth of an optical circulator configured for use with signals within the two micron wavelength region.

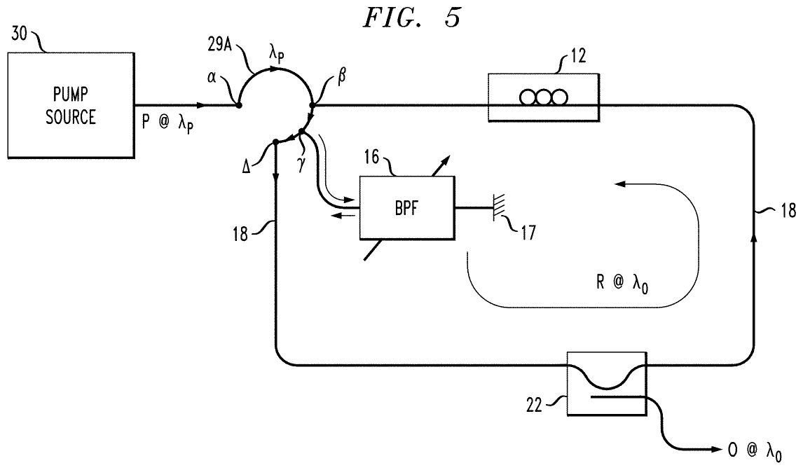

Instead of using a pair of three-port polarization-maintaining optical circulators, it is possible to utilize a single four-port polarization-maintaining optical circulator to form a fiber ring laser in accordance with the principles of the present invention. FIG. 5 illustrates an exemplary fiber ring laser 10D formed to utilize a single, four-port optical circulator 29A to provide the interconnections between pump source 30, gain module 12, and tunable BPF 16. Four-port optical circulator 29A is shown as forming a unidirectional signal path from a first port α to a second port β, followed by a polarization-maintaining signal path from second port β to a third port γ. A second polarization-maintaining signal path is provided between third port γ and a fourth port Δ. First port α may be defined as an “input” port and fourth port Δ may be defined as an “output” port.

In this configuration, pump source 30 is shown as coupled to first port α, allowing an input pump beam P (operating at pump wavelength λ_{P}) to propagate through optical circulator 29A to exit at second port β. The signal path between first port a and second port β may comprise a conventional single mode fiber or the like. Upon reach second port β, pump beam P exits and is injected into gain module 12 in the same manner as discussed above. The amplified laser radiation R created within PM gain module 12 is directed into second port β of circulator 29A, where it propagates along a polarization-maintaining signal path and exists at third port γ. As shown, the combination of tunable BPF 16 and reflector 17 is disposed along a linear signal path from third port γ. Thus, similar to the operation of second three-port optical circulator 29-2 discussed above, the amplified laser radiation R exiting from gain module 12 passes back and forth along BPF 16 and thereafter re-inserted into four-port optical circulator 29A at third port γ. The amplified, filtered laser radiation R then propagates along a polarization-maintaining path to output port Δ of four-port circulator 29A, where it is then directed into a section of PM optical fiber 18. As with various other embodiments described above, output coupler 22 is disposed beyond PM optical fiber 18 and used to out-couple a portion of the circulating laser radiation R as the output laser beam O (operating at a selected λ₀ controlled by adjusting the center wavelength of tunable BPF 16) from tunable fiber ring laser 10D.

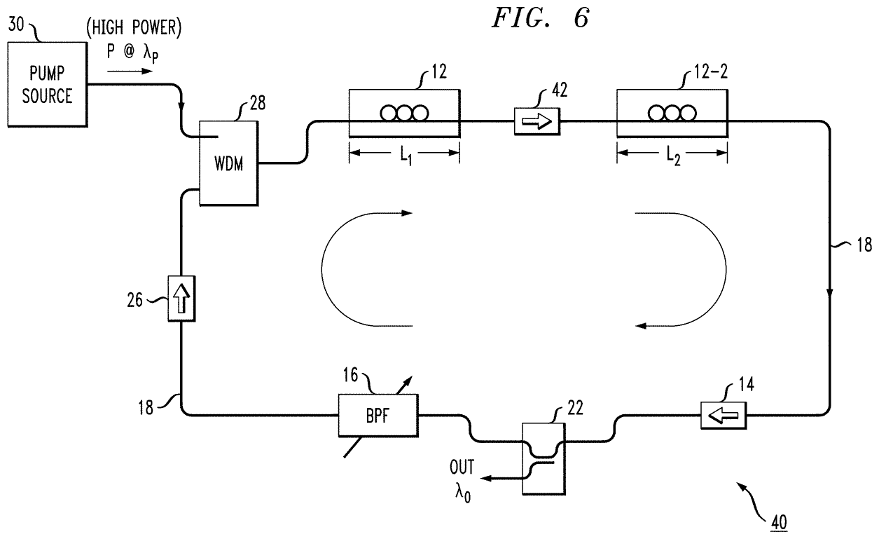

FIG. 6 illustrates another exemplary embodiment of a tunable PM-fiber ring laser formed in accordance with the principles of the present invention. In this case, a tunable PM-fiber ring laser 40 is formed to include an additional gain module within the ring structure to boost the level of power generated within the ring, so as to achieve a multi-watt output power. In particular, a second gain module 12-2 is positioned to immediately follow original gain module 12, being separated therefrom by a PM optical isolator 42. The inclusion of PM optical isolator 42 has been found to improve the gain and power saturation characteristics of the fiber ring laser by preventing backward-propagating ASE from second gain module 12-2 from entering original gain module 12.

In accordance with this embodiment of the present invention, pump beam P from pump source 30 first passes through gain module 12, and is thereafter coupled into second gain module 12-2. Since the same pump beam is used to generate amplification in both gain modules, the same type of PM gain fiber is used to form each module (i.e., both using Tm—Ho co-doped PM fiber or both using Ho-doped PM fiber). Inasmuch as the pump wavelength used for Tm-based applications cannot be transmitted through PM optical isolator 42, this configuration is workable only for H-doped gain modules or Tm—Ho co-doped gain modules.

As with the embodiments described above, PM-based, tunable BPF 16 functions to provide an adjustment of the filter's center wavelength within a wavelength range associated with the particular dopant within the PM gain fiber forming modules 12, 12-2. When using Ho-doped gain fiber (with a tunable output laser wavelength range of about 2000-2150 nm), a pump beam operating at a wavelength λ_{P} of 1850 nm or 1940 nm may be used. The input power of pump beam P, as well as the lengths L1, L2 and absorption coefficients σ1, σ2 of the doped gain fibers within modules 12 and 12-2, respectively, may all be designed and controlled to ensure that sufficient pump power remains to generate additional gain within the laser radiation propagating through second gain module 12-2. The remainder of the PM optical components of tunable fiber ring laser 40 (i.e., PM isolators 14 and 26, polarization-maintaining tunable BPF 16, PM output coupler 22, and polarization-maintaining WDM 28) function in the same manner as discussed above, where these components are coupled together in a ring structure using sections of PM optical fiber 18 in accordance with the principles of the present invention.

In the arrangement as shown in FIG. 6, PM output coupler 22 is positioned in the signal path immediately after power-boosting second gain module 12-2 so that a significant fraction of the high power level achieved by adding the additional gain module may be out-coupled being propagating through other elements within the ring structure. By using this arrangement, PM-based, tunable BPF 16 and PM optical isolator 26 are protected from being exposed to the higher levels of power achieved with a two-stage gain arrangement.

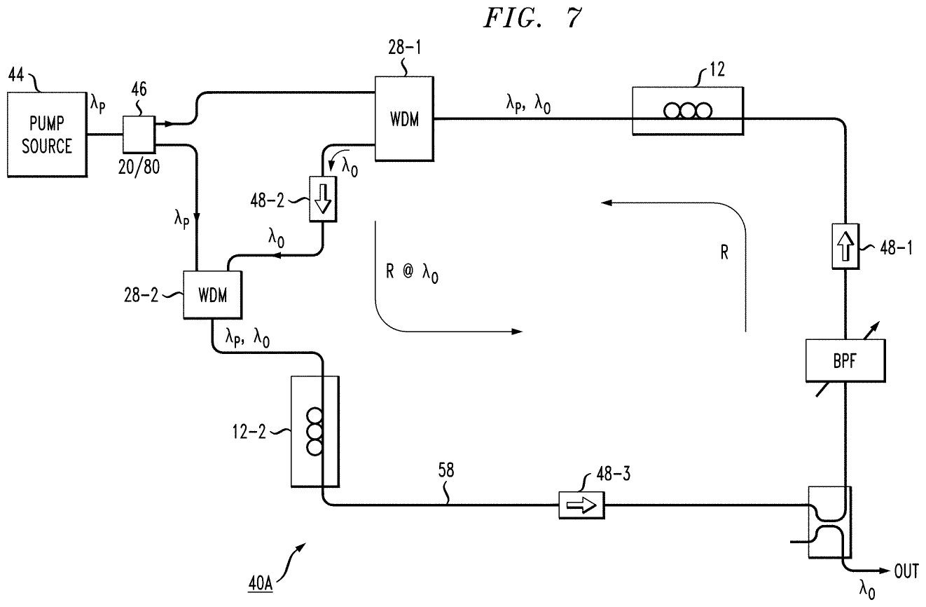

FIG. 7 illustrates an alternative configuration of the higher power embodiment of FIG. 6; that is, utilizing a pair of separate gain modules 12 and 12-2 to provide amplification within the ring structure of a tunable fiber ring laser. In this case, FIG. 7 shows a tunable PM-fiber ring laser 40A where second gain module 12-2 is positioned at a spaced-apart location from original gain module 12. A pump source 44 is included within tunable PM-fiber ring laser 40A and used to provide individual pump beams to each gain module. While it is possible to utilize a pump source 44 that comprises a pair of stand-alone discrete semiconductor lasers that are individually coupled to each gain module, it is also possible to divide a single pump beam into a pair of sub-beams, with each sub-beam coupled to a separate one of the gain modules. FIG. 7 illustrates the latter approach.

As with the embodiment of FIG. 6, it is presumed that gain modules 12 and 12-2 are both based on the use of the same dopant within the sections of PM fiber, even though separate pump beam inputs are applied to each gain module, since a common pump source 44 is used in this case to create the pair of pump beams. In this case, a power splitter 46 is disposed at the output of pump source 44 and used to direct a first sub-beam P₁ toward original gain module 12 and a second sub-beam P₂ toward second gain module 12-2.

Similar to the configuration of FIG. 2, tunable fiber ring laser 40A of FIG. 7 is configured to have the amplified, polarization-maintaining laser radiation R circulate in a counter-clockwise direction around the fiber ring, as controlled by PM optical isolators 48-1, 48-2, and 48-3 disposed around the ring as shown. A first polarization-maintaining WDM 28-1 is disposed to receive first pump sub-beam P₁ (operating at pump wavelength λ_{P}) and couple this sub-beam into original gain module 12. The amplified laser radiation R generated within gain module 12 is re-directed by PM optical isolator 48-1 to pass again through gain module 12 and thereafter be provided as an input to WDM 28-1. The laser radiation R (propagating at selected wavelength λ₀ controlled by tuning PM-based, tunable BPF 16) is directed through polarization-maintaining WDM 28-1 to exit along an output port and be coupled into a section of PM optical fiber 18. This amplified laser radiation R then passes through PM optical isolator 48-2 to thereafter propagate along PM optical fiber 18.

Laser radiation R (propagating at the “tuned” output wavelength λ₀) is then applied as a first input to a second polarization-maintaining WDM 28-2, where second pump sub-beam P₂ (operating at λ_{P}) is shown as applied as a second input to polarization-maintaining WDM 28-2. WDM 28-2 functions to multiplex both laser radiation R (propagating at tuned wavelength λ₀) and second pump sub-beam P₂ (propagating at pump wavelength λ_{P}) onto a section of PM optical fiber 18 that directs both radiation R and pump sub-beam P₂ into second gain module 12-2. Amplified laser radiation R exits second gain module 12-2 and passes through PM optical isolator 48-3 before entering PM output coupler 22. Here, the portion of laser radiation R that is not out-coupled continues to propagate along PM optical fiber 18 prior to being applied as an input to a tunable BPF 16 (also formed of PM optical fiber). It is to be recalled that tunable BPF 16 may comprise any suitable device that is able to achieve wavelength tuning over a defined range while maintaining polarization of the beam.

In accordance with this embodiment of the present invention, the use of two separate, spaced-apart amplifying stages allows for the laser power to be boosted immediately prior to out-coupling a portion of beam, thus providing a higher power laser output than possible with the configuration shown in FIG. 6. An advantage of tunable fiber laser 40A, therefore, is that a higher output power can be extracted without the need to expose tunable BPF 16 to a high power level. Alternatively, as discussed above in association with the embodiments of FIGS. 1 and 2, PM-based, tunable BPF 16 may be positioned at the input to PM output coupler 22 in order to improve the signal OSNR of the output from tunable PM-fiber ring laser 40A.

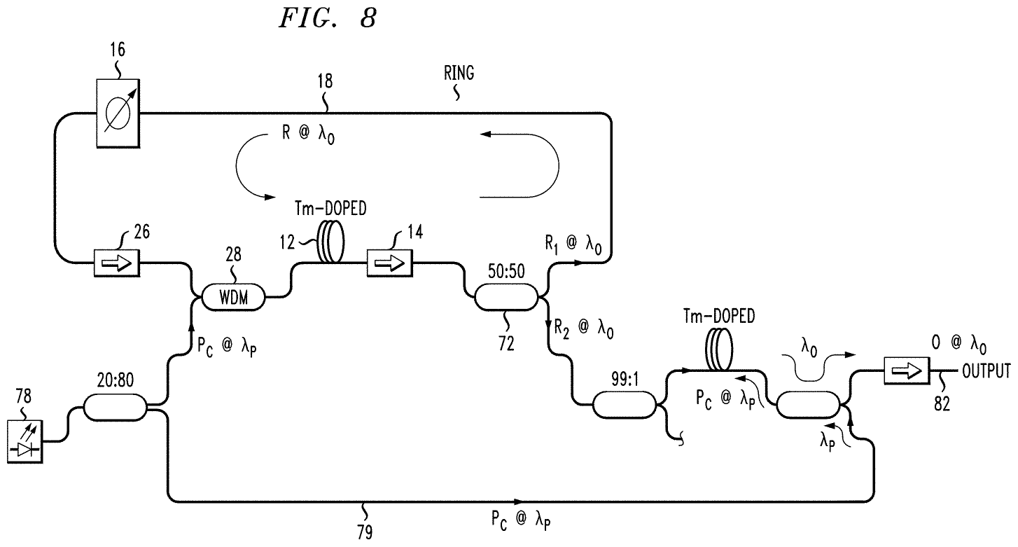

FIG. 8 illustrates yet another embodiment of the present invention. In this case, a PM-based, tunable PM-fiber laser 70 includes a second, separate amplifying stage (also referred to as a power boosting stage, or simply a booster stage) that is coupled to the output of the fiber ring structure of the laser structure. Particularly well-suited for higher power applications, the booster stage may utilize a relatively high power pump beam in conjunction a particularly-configured section of doped gain fiber to generate a laser output of 10 W or higher.

In particular, tunable fiber laser 70 can be contemplated as comprising a tunable fiber ring laser 10 or 40 (including their various configurations) as discussed above in association with FIGS. 1-7, with an additional power boosting stage coupled to the output from the ring. By separating the generation of multi-watt power levels from the tuning and control of the output wavelength, the components in the ring will not be subjected to the types of damage associated with exposure to high power levels.

For the particular embodiment as shown in FIG. 8, a ring laser portion similar to fiber ring laser 10 is utilized, except that PM output coupler 22 is replaced by a polarization-maintaining 50/50 power splitter 72 that directs a first portion of the amplified laser radiation (defined as R₁) to continue to circulate around the ring, with a second portion R2 directed out of the ring along a section of PM optical fiber 74 and into a gain module 76. A pump source 78 is included within fiber laser 70 and in this case used to supply pump beams at the appropriate pump wavelength λ_{P} to both the fiber ring and the power booster stages. Amplification within the ring occurs in the same manner as discussed above, with the output wavelength λ₀ of the laser radiation circulating within the ring controlled by adjusting the center wavelength of PM-based, tunable BPF 16.

A separate pump beam PC from pump source 78 is used in accordance with this embodiment of the present invention to increase the optical power of the signal propagating through gain module 76. As shown, pump beam PC propagates along a section of conventional single mode fiber 79, and is thereafter applied as an input to a polarization-maintaining WDM 80. Polarization-maintaining WDM 80 is positioned at the output of gain module 76 and used to couple pump beam PC (operating at a suitable pump wavelength λ_{P}) into gain module 76 to be used as a counter-propagating pump beam. The amplified output from gain module 76 is thereafter directed by WDM 80 onto an output signal path 82 that outputs the amplified signal via an optical isolator, as shown.

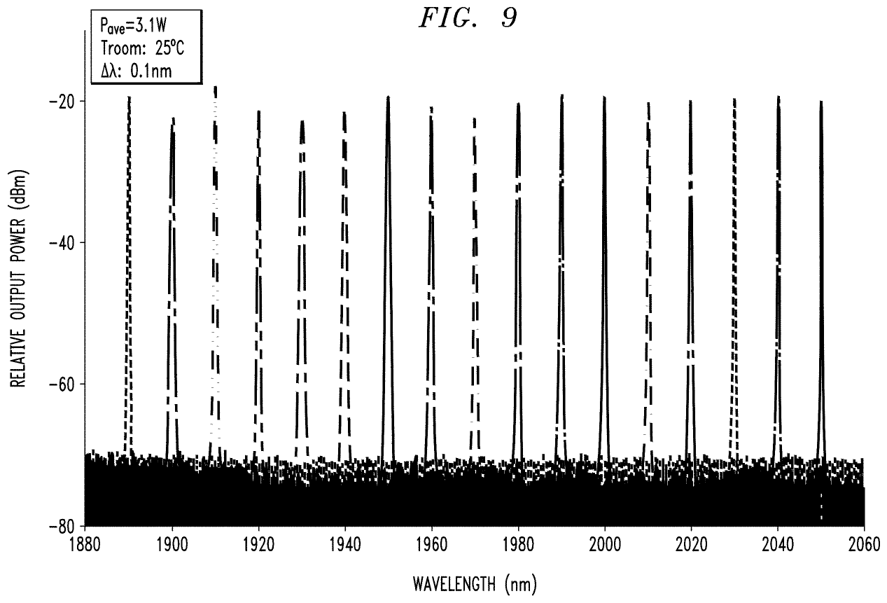

FIG. 9 shows an exemplary output spectrum for a configuration of tunable PM-fiber laser 70 based upon the use of TM-doped PM optical fiber within gain modules 12 and 76. In particular, the spectrum in FIG. 9 illustrates the results associated with tuning polarization-maintaining BPF 16 along a wavelength range extending from 1890 nm to 2050 nm. The amplified output linewidth may be measured with an optical spectrum analyzer, and has been found to be less than 0.05 nm (4 GHz). At each of these wavelengths, the PM output power of tunable fiber laser 70 was over 1.5 W CW.

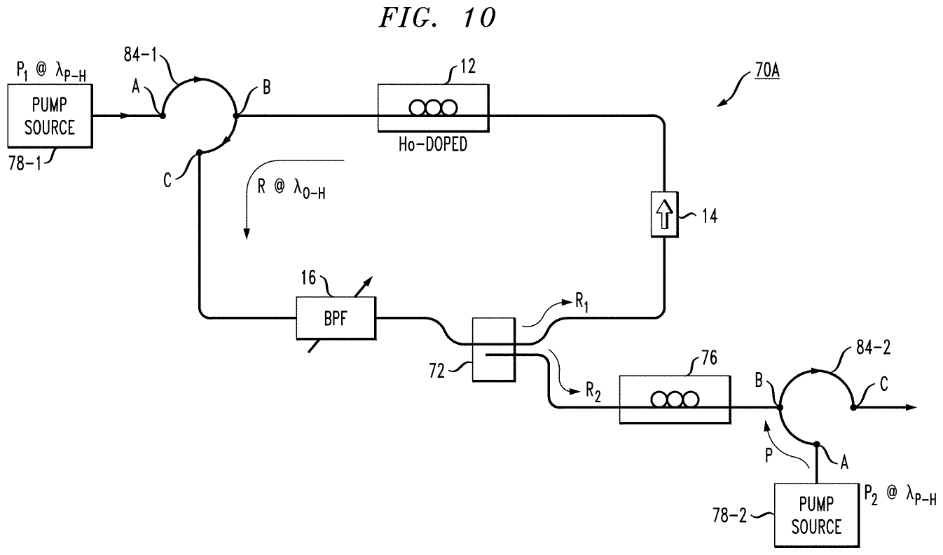

Similar to the configurations discussed above in association with FIGS. 3-5, fiber laser 70 may also be configured to utilize polarization-maintaining optical circulators in place of the WDM/isolator combination when using either Ho-doped or Tm—Ho co-doped gain fibers and a pump wavelength within the same transmission bandwidth as the laser output. FIG. 10 illustrates an exemplary tunable PM-fiber laser 70A that utilizes a first three-port PM optical circulator 84-1 to provide connection between gain module 12, PM-based, tunable BPF 16 and a first pump source 78-1. A first pump beam P1 is coupled into port A of PM optical circulator 84-1, where it propagates within the circulator and exits at port B to be coupled into gain module 12 (to create optical gain in the manner described above). The amplified laser radiation R from gain module 12 is directed into port B to propagate along polarization-maintaining optical circulator 84-1 and exit at port C, which is coupled to a section of PM fiber 18 extending between PM optical circulator 84-1 and PM-based, tunable BPF 16.

A second three-port polarization-maintaining optical circulator 84-2 is shown as included in the output, power amplifying stage that is disposed beyond the ring structure (used for output wavelength tuning) of tunable fiber laser 70A. In this case, a second pump source 78-2 is coupled to port A2 of second PM optical circulator 84-2, passing along the circulator to exit at port B2. As shown, the output from gain module 76 is coupled to port B2, allowing the applied pump beam to counter-propagate through gain module 76. The amplified laser output O from gain module 76 is subsequently introduced to second PM optical circulator 84-2 at port B2, where it propagates along to exit at port C2, which is coupled to polarization-maintaining output fiber 82.

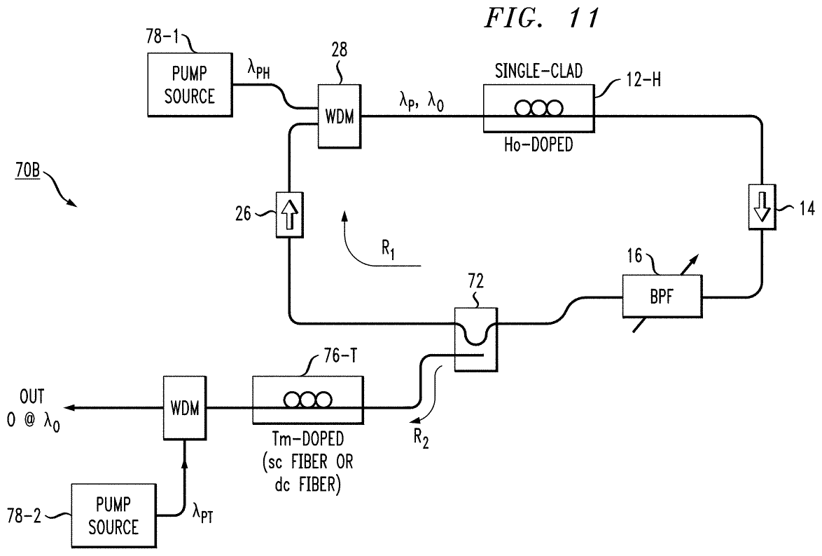

FIG. 11 illustrates an exemplary tunable fiber laser 70B, where gain module 12 is formed of Ho-doped PM optical fiber (identified as 12-H) and gain module 76 is formed of Tm-doped polarization maintaining fiber (identified as 76-T). In association with these selections, first pump source 78-1 is configured to provide a pump beam at a wavelength λ_{PH} best-suited for use with Ho-doped gain fiber, for example, λ_{PH}=1940 nm. Second pump source 78-2 is shown as providing a pump beam at a wavelength of λ_{PT}=1567 nm for providing amplification within the Tm-doped fiber of gain module 76-T.

While not explicitly illustrated in FIG. 11, it is possible to utilize a Tm—Ho co-doped gain fiber within gain module 76. In this case, a pump beam operating at a wavelength of 1567 nm can be used with a single clad fiber, or the pump may operate at a wavelength of 793 nm when using a double-clad polarization-maintaining fiber to impart gain to both dopants and substantially increase the output power that may be generated.

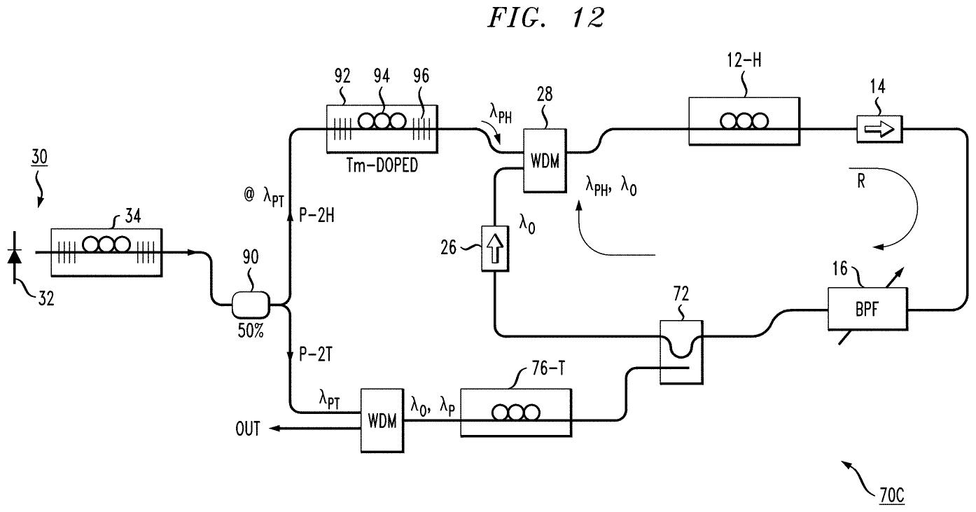

FIG. 12 depicts an alternative configuration to fiber laser 70B of FIG. 11. In particular, fiber laser 70C of FIG. 12 is based upon the use of a single pump supply for both the Ho-doped gain module 12-H within the ring and the Tm-doped gain module 76-T within the booster stage. In the particular embodiment of FIG. 12, the single pump supply is formed by a version of pump source 30 that includes the combination of 940 nm laser diode 32 and Er—Yb fiber laser 34. The output from pump source 30 is therefore a first pump beam P-1 operating at a wavelength of 1567 nm, suitable for use in generating gain within a Tm-doped polarization-maintaining gain fiber.

First pump beam P-1 is passed through an optical power splitter 90, which directs a first portion of this beam into the ring structure (denoted as P-2H) and a second into the booster structure (denoted as P-2T). In order to create a pump beam operating at a wavelength suitable for use with the polarization-maintaining Ho-doped gain fiber within gain module 12-H (i.e., creating a pump wavelength for use within the ring laser), first pump portion P-2H is shown as applied as an input to a fiber laser 92. As shown, fiber laser 92 comprises a section of Tm-doped gain fiber 94 disposed between a pair of FBGs 96. The interaction of first pump portion P-2H with fiber laser 92 creates an output pump beam P-O operating at a wavelength λ_{PH} of 1940 nm (or perhaps 1860 nm).

Pump beam P-O is thereafter applied as an input to polarization-maintaining WDM 28, where as discussed above the circulating laser radiation R operating at a selected wavelength λ0 is supplied as a second input to polarization-maintaining WDM 28. Thereafter, in a manner similar to those described above, the combination of pump beam P-O and laser radiation R passes through the Ho-doped polarization-maintaining fiber within gain module 12-H, increasing the gain of laser radiation R prior to reaching power splitter 72.

In the particular configuration as shown in FIG. 12 it is to be noted that the booster stage of the fiber laser may be formed of conventional (i.e., non-PM) optical fiber, and gain module 76-T may utilize a section of either single-clad or double-clad Tm-doped fiber. Polarization-maintaining fiber is a necessary component of only of the ring portion of the fiber laser, as a condition required to maintain the resonant structure of the ring.

Summarizing, a tunable polarization-maintaining Tm-doped and/or Ho-doped optically amplified fiber ring laser is proposed. Various configurations described above require a minimal number of individual components and, as a result, may be assembled in a compact OEM package suitable for integration into manufacturing or laboratory applications. The inventive fiber laser has a tuning range of 1890-2050 nm, an experimentally measured linewidth of <0.05 nm (<4 GHz), and peak fiber coupled output powers of >3.5 W CW. Applications include sources for component and system evaluation, mid-IR generation, LIDAR, DWDM, and coherent systems, and infrared spectroscopy and gas sensing applications.

While there is shown and described herein certain specific structures embodying the present invention, it will occur to those skilled in the art that various modifications and re-arrangements of the components may be made without departing from the spirit and scope of the underlying inventive concept; thus the same is not limited to the particular forms herein shown and described except insofar as indicated by the scope of the claims appended hereto.

What is claimed is:

1. A wavelength-tunable, polarization-maintaining fiber laser operable in the two micron region, comprising
a polarization-maintaining ring resonator structure including
a gain module of polarization-maintaining optical fiber including a dopant selected from the group consisting of: Thulium (Tm), Holmium (Ho), and Thulium-Holmium (Tm—Ho);
a polarization-maintaining bandpass filter configured as a tunable device for selecting a particular laser output wavelength from within the two micron region; and
a polarization-maintaining output coupler for out-coupling a defined fraction of the laser radiation generated at the selected output wavelength within the gain module, a remaining fraction of the laser radiation continuing to circulate through the gain module and the polarization-maintaining bandpass filter and provide a continuous laser radiation output from the ring resonator structure; and
a pump source coupled to the polarization-maintaining ring resonator structure, the pump source providing a pump beam to the gain module at a pump wavelength known to generating gain in the presence of the selected dopant.

2. The wavelength-tunable, polarization-maintaining fiber laser as defined in claim 1 wherein the polarization-maintaining, tunable bandpass filter is disposed in the signal path prior to the polarization-maintaining output coupler so as to reduce noise in the out-coupled laser radiation.

3. The wavelength-tunable, polarization-maintaining fiber laser as defined in claim 1 wherein the polarization-maintaining, tunable bandpass filter is disposed in the signal path after the polarization-maintaining output coupler so as to reduce a power level of the laser radiation passing through the polarization-maintaining, tunable bandpass filter.

4. The wavelength-tunable, polarization-maintaining fiber laser as defined in claim 1 wherein the polarization-maintaining, tunable bandpass filter comprises a passive device providing an initial selection of the laser output wavelength that is thereafter maintained at the same value.

5. The wavelength-tunable, polarization-maintaining fiber laser as defined in claim 1 wherein the polarization-maintaining, tunable bandpass filter comprises an active device providing the ability to adjust a selected output wavelength for the laser radiation over time.

6. The wavelength-tunable, polarization-maintaining fiber laser as defined in claim 1 wherein the polarization-maintaining ring resonator structure further comprises a polarization-maintaining wavelength division multiplexer (WDM) disposed to receive as a first input the pump beam from the pump source, and receive as a second input the circulating laser radiation, their combination forming the output from the polarization-maintaining WDM, thereafter provided as an input to the gain module.

7. The wavelength-tunable, polarization-maintaining fiber laser as defined in claim 1 wherein the polarization-maintaining fiber within the gain module comprises an Ho-doped fiber, and the polarization-maintaining ring resonator structure further comprises
a polarization-maintaining three-port optical circulator, wherein the pump source is coupled to a first port and the gain module is coupled to a second port, the propagation direction controlled within the polarization-maintaining three-port optical circulator such that an amplified laser radiation output from the gain module exits at a third port, the third port coupled to a polarization-maintaining signal path within the polarization-maintaining ring resonator structure.

8. The wavelength-tunable, polarization-maintaining fiber laser as defined in claim 7, wherein the polarization-maintaining ring structure further comprises an additional polarization-maintaining three-port optical circulator, wherein the polarization-maintaining output coupler is coupled to a first port and the polarization-maintaining, tunable bandpass fiber is coupled to the second port

9. The wavelength-tunable, polarization-maintaining fiber laser as defined in claim 1 wherein the polarization-maintaining fiber within the gain module comprises an Ho-doped fiber, and the polarization-maintaining ring resonator structure further comprises
a polarization-maintaining four-port optical circulator, wherein the pump source is coupled to a first port, the gain module is coupled to a second port, and the polarization-maintaining bandpass filter is coupled to a third port, the propagation direction controlled within the polarization-maintaining four-port optical circulator such that a filtered, amplified laser radiation output from the polarization-maintaining bandpass filter exits at a fourth port, the fourth port coupled to a polarization-maintaining signal path within the polarization-maintaining ring resonator structure.

10. The wavelength-tunable, polarization-maintaining fiber laser as defined in claim 1 wherein the polarization-maintaining ring resonator structure further comprises at least one additional gain module for increasing an achievable power level of the output laser radiation.

11. The wavelength-tunable, polarization-maintaining fiber laser as defined in claim 10 wherein at least one additional gain module is disposed in series with the original gain module, separated therefrom by a polarization-maintaining optical isolator.

12. The wavelength-tunable, polarization-maintaining fiber laser as defined in claim 10 wherein the pump beam has a power level sufficient to propagate through and generate increased optical power within all gain modules disposed in series.

13. The wavelength-tunable, polarization-maintaining fiber laser as defined in claim 10 wherein at least one additional gain module is disposed immediately prior to the polarization-maintaining output coupler.

14. The wavelength-tunable, polarization-maintaining fiber laser as defined in claim 13 wherein the pump source includes a power splitter for creating a pair of sub-beams from the pump beam, a first sub-beam coupled into the original gain module and a second sub-beam coupled into the at least one additional gain module.

15. The wavelength-tunable, polarization-maintaining fiber laser as defined in claim 13 wherein the pump source comprises a pair of separate pump source elements, a first source element providing a pump beam to the original gain module and the second source element providing a pump beam to the at least one additional gain module.

16. The wavelength-tunable, polarization-maintaining fiber laser as defined in claim 15 wherein the selected dopant within the original gain module is different from the selected dopant within the at least one additional gain module, and the pump wavelengths of the pair of separate pump source elements are selected so as to achieve gain within the associated gain module.

17. The wavelength-tunable, polarization-maintaining fiber laser as defined in claim 1, further comprising
a polarization-maintaining power boosting fiber amplifier coupled to the output path of the polarization-maintaining output coupler and comprising a polarization-maintaining optical fiber with a gain dopant selected from the group consisting of: Thulium (Tm), Holmium (Ho), and Thulium-Holmium (Tm—Ho).

18. The wavelength-tunable, polarization-maintaining fiber laser as defined in claim 17 wherein the pump source includes a power splitter for directing a first portion of the pump beam to the polarization-maintaining ring resonator structure and a second portion of the pump beam to the polarization-maintaining power boosting fiber amplifier.

19. The wavelength-tunable, polarization-maintaining fiber laser as defined in claim 17, further comprising
a multi-watt power pump source for providing a high power pump beam input to the polarization-maintaining power boosting fiber amplifier.

20. The wavelength-tunable, polarization-maintaining fiber laser as defined in claim 19 wherein the polarization-maintaining optical fiber within the polarization-maintaining power boosting fiber amplifier comprises a double-clad optical fiber for generating output power levels in excess of ten watts.
